(19) United States
(12) Patent Application Publication
(10) Pub. No.: US 2015/0194265 A1
(43) Pub. Date: Jul. 9, 2015

(54) METHOD FOR MANUFACTURING ELECTRICITY STORAGE DEVICE

(71) Applicant: JTEKT CORPORATION, Osaka-shi (JP)

(72) Inventor: Kazuhisa SUGIYAMA, Okazaki-shi (JP)

(73) Assignee: JTEKT CORPORATION, Osaka-shi (JP)

(21) Appl. No.: 14/580,363

(22) Filed: Dec. 23, 2014

(30) Foreign Application Priority Data
Jan. 6, 2014 (JP) 2014-000082

(51) Int. Cl. H01G 4/26; H01M 10/04

(52) U.S. Cl. CPC H01G 4/26; H01M 10/0431

(57) ABSTRACT

An electricity storage member in an electricity storage device is manufactured by a step of folding a positive electrode material foil and folding a negative electrode material foil, a step of arranging the positive and negative electrode material foils with a separator foil interposed therebetween, and a step of positioning the positive and negative electrode material foils by relatively moving the positive and negative electrode material foils toward each other so as to insert one end of a second material foil among the positive and negative electrode material foils into a bottom of a valley of the first material foil, and restraining the one end of the second material foil with the bottom of the valley of the first material foil.

### INCORPORATION BY REFERENCE

The disclosure of Japanese Patent Application No. 2014-000082 filed on Jan. 6, 2014 including the specification, drawings and abstract, is incorporated herein by reference in its entirety.

### BACKGROUND OF THE INVENTION

1. Field of the Invention

The invention relates to manufacturing methods of an electricity storage device such as a capacitor and a battery.

2. Description of the Related Art

Japanese Patent Application Publication Nos. 2007-220696 (JP 2007-220696 A) and 2008-258222 (JP 2008-258222 A) and Japanese Patent No. 4441976 describe electricity storage devices such as a capacitor and a battery, which include an electricity storage member in which positive electrode foils and negative electrode foils are alternately stacked with separator foils interposed therebetween.

The electricity storage member described in JP 2007-220696 A is manufactured by placing folded separator foils between the positive electrode foils and the negative electrode foils, and moving the positive electrode foils and the negative electrode foils toward each other. The electricity storage member described in JP 2008-258222 A is manufactured by stacking a positive electrode material foil having a length equal to the sum of the lengths of a multiplicity of positive electrode foils, a negative electrode material foil having a length equal to the sum of the lengths of a multiplicity of negative electrode foils, and separator foils interposed between the positive and negative electrode material foils, and winding or zigzag-folding the stack. The electricity storage member described in Japanese Patent No. 4441976 is manufactured by stacking a positive electrode material foil having a length equal to the sum of the lengths of a multiplicity of positive electrode foils, a negative electrode material foil having a length equal to the sum of the lengths of a multiplicity of negative electrode foils, and separator foils interposed between the positive and negative electrode material foils, and zigzag-folding the stack.

The region where the positive electrode foil and the negative electrode foil overlap each other affects performance of the capacitor or the battery. If the positive electrode foil and the negative electrode foil are offset from each other, this overlapping region is reduced, and the size of the capacitor or the battery need be increased accordingly in order to ensure the electricity storage capacity. It is therefore desired to accurately position the positive electrode foils and the negative electrode foils in order to reduce the size while improving performance.

In the electricity storage member described in JP 2007-220696 A, it is not easy to accurately position the positive electrode foils and the negative electrode foils. In this electricity storage member, the positive electrode foils and the negative electrode foils can be positioned by using fold lines in the separator foils. However, this is not easy because of low rigidity of the separator foils.

The electricity storage member described in JP 2008-258222 A is formed by winding or zigzag-folding the stack of the positive electrode material foil, the negative electrode material foil, and the separator foil. Accordingly, the area of the region (non-deposited portion) that does not affect performance is increased as the number of turns is increased. The size of the electricity storage member is therefore increased as the number of turns is increased. In the electricity storage member described in Japanese Patent No. 4441976, it is not easy to fold the strip-shaped positive electrode material foil, the strip-shaped separator foil, and the strip-shaped negative electrode material foil at accurate folding positions. Accordingly, the size of this electricity storage member may be increased as the number of stacks is increased.

### SUMMARY OF THE INVENTION

It is an object of the invention to provide a method for manufacturing an electricity storage device capable of achieving both improved performance and a reduced size.

A method for manufacturing an electricity storage device according to one aspect of the invention is a method for manufacturing an electricity storage device including an electricity storage member in which positive electrode foils and negative electrode foils are alternately stacked with separator foils interposed therebetween, including:

a positive electrode folding in which a positive electrode material foil having a length equal to a sum of lengths of two of the positive electrode foils is folded in a middle;

a negative electrode folding in which a negative electrode material foil having a length equal to a sum of lengths of two of the negative electrode foils is folded in a middle;

an initial arranging in which the positive electrode material foil and the negative electrode material foil are arranged with the separator foils interposed therebetween such that an opening of the folded positive electrode material foil faces an opening of the folded negative electrode material foil; and

a positioning in which the positive electrode material foil and the negative electrode material foil are positioned by relatively moving the folded positive electrode material foil and the folded negative electrode material foil closer to each other so as to insert one end of a second material foil among the positive and negative electrode material foils from the opening of a first material foil among the positive and negative electrode material foils toward a bottom of a valley of the first material foil, and in which the one end of the second material foil is restrained with the bottom of the valley of the first material foil.

As described above, the electricity storage member uses the positive electrode material foil having a length equal to the sum of the lengths of the two positive electrode foils and the negative electrode material foil having a length equal to the sum of the lengths of the two negative electrode foils. The positive electrode material foil and the negative electrode material foil are positioned as the one end of the folded second material foil is restrained by the bottom of the valley of the folded first material foil. Because the positive electrode material foil is more rigid than the separator foil, rigidity at the bottom of the valley of the first material foil is higher than that at the fold line of the separator foil. The positive electrode material foil and the negative electrode material foil are thus accurately positioned by the above positioning method. As a result, the electricity storage device manufactured as described above can achieve both improved performance and a reduced size.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic perspective view of an electricity storage device according to a first embodiment of the invention;

FIG. 2 is a schematic plan view of the electricity storage device shown in FIG. 1;

FIG. 3 is a perspective view illustrating a method for manufacturing an electricity storage member of the electricity storage device shown in FIG. 1;

FIG. 4A shows an initial state in the method for manufacturing the electricity storage member shown in FIG. 3;

FIG. 4B shows a state where a plurality of positive electrode material foils have been moved from the initial state shown in FIG. 4A;

FIG. 4C shows a state where one negative electrode material foil has been moved from the state shown in FIG. 4B;

FIG. 4D shows a state where another one negative electrode material foil has been moved from the state shown in FIG. 4C;

FIG. 4E shows a state where the electricity storage member is manufactured by compressing the positive electrode material foils, the negative electrode material foils, and separator foil in the state shown in FIG. 4D;

FIG. 5 is a diagram showing an initial state in a method for manufacturing an electricity storage member of an electricity storage device according to a second embodiment;

FIG. 6 is a perspective view showing a method for manufacturing an electricity storage member of an electricity storage device according to a third embodiment;

FIG. 7A shows an initial state in the method for manufacturing the electricity storage member shown in FIG. 6;

FIG. 7B shows a state where a plurality of positive electrode material foils have been moved from the initial state shown in FIG. 7A;

FIG. 7C shows a state where one negative electrode material foil has been moved from the state shown in FIG. 7B; and

FIG. 7D shows a state where negative electrode material foils have been sequentially moved from the state shown in FIG. 7C.

### DETAILED DESCRIPTION OF EMBODIMENTS

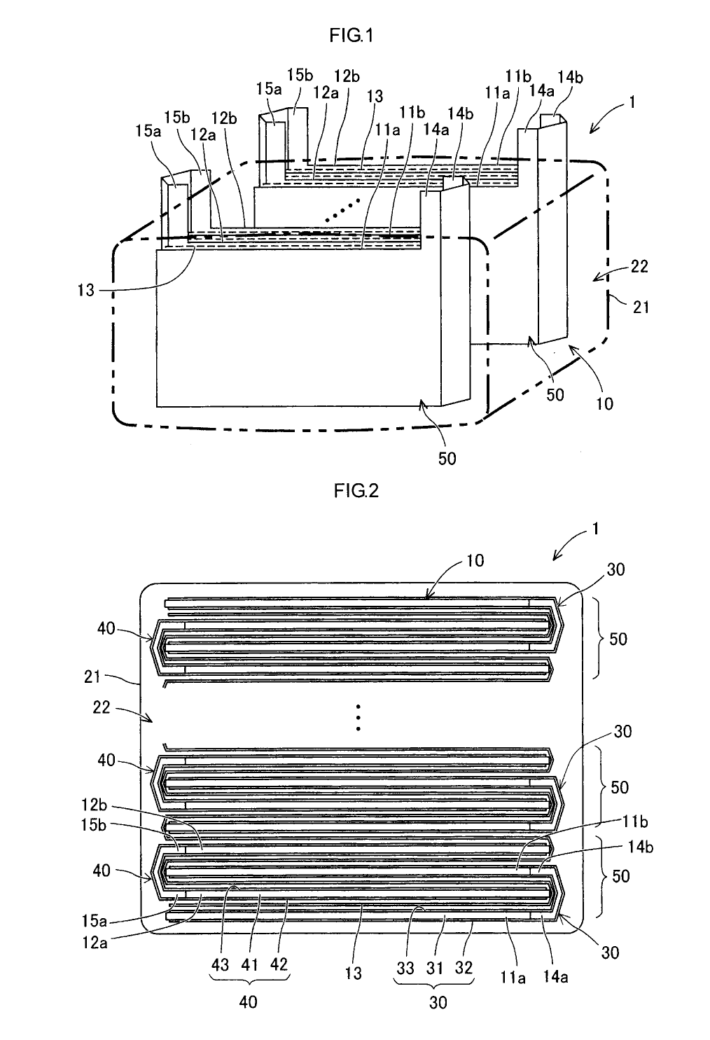

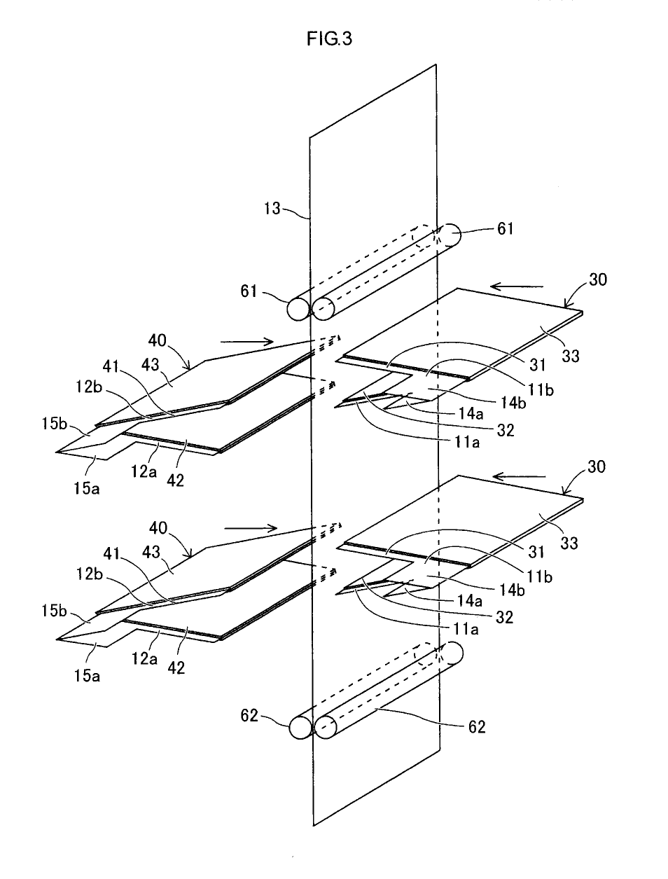

A first embodiment of the invention will be described below with reference to the accompanying drawings. First, the configuration of an electricity storage device will be described. The electricity storage device is a capacitor, a battery, etc. In the present embodiment, a lithium ion capacitor 1 will be described as an example of the electricity storage device. As shown in FIGS. 1 and 2, the lithium ion capacitor 1 includes an electricity storage member 10, a bag-shaped cover 21 (shown by a long dashed double-short dashed line in FIG. 1) that contains and seals the electricity storage member 10, and an electrolyte solution 22 that is enclosed in the cover 21. Although not shown in the figure, the lithium ion capacitor 1 includes a doping member that dopes negative electrode foils 12a, 12b with lithium ions in a manufacturing process.

The electricity storage member 10 includes a plurality of positive electrode foils 11a, 11b, a plurality of negative electrode foils 12a, 12b, a plurality of separator foils 13, positive external terminals 14a, 14b, and negative external terminals 15a, 15b. As shown in FIG. 2, in the electricity storage member 10, the positive electrode foils 11a, 11b and the negative electrode foils 12a, 12b are alternately stacked with the separator foils 13 interposed therebetween. That is, in the electricity storage member 10, the positive electrode foils 11a, 11b, the negative electrode foils 12a, 12b, and the separator foils 13 are repeatedly stacked in order of the positive electrode foil 11a, the separator foil 13, the negative electrode foil 12a, the separator foil 13, the positive electrode foil 11b, the separator foil 13, and the negative electrode foil 12b. The length of each positive electrode foil 11a, 11b corresponds to the lateral width of the electricity storage member 10 shown in FIGS. 1 and 2. The length of each negative electrode foil 12a, 12b corresponds to the lateral width of the electricity storage member 10 shown in FIGS. 1 and 2.

The positive external terminals 14a, 14b are provided integrally with the ends (upper right ends in FIG. 1) of the positive electrode foils 11a, 11b, respectively. The plurality of positive external terminals 14a, 14b are electrically connected by, e.g., welding etc. The negative external terminals 15a, 15b are provided integrally with the ends (upper left ends in FIG. 1) of the negative electrode foils 12a, 12b, respectively. The plurality of negative external terminals 15a, 15b are electrically connected by, e.g., welding etc. The positive external terminals 14a, 14b and the negative external terminals 15a, 15b are terminals for connection with an external device, and are provided so as to protrude from the cover 21.

As shown in FIGS. 1 and 2, adjoining two of the positive electrode foils 11a, 11b and their corresponding positive external terminals 14a, 14b are formed by an integral positive electrode material foil 30. That is, a single positive electrode material foil 30 is folded in the middle to be divided into a surface having the first positive electrode foil 11a and the first positive external terminal 14a and a surface having the second positive electrode foil 11b and the second positive external terminal 14b. That is, the length of the single positive electrode material foil 30 is equal to the sum of the lengths of the two positive electrode foils 11a.

The positive electrode material foil 30 includes a positive current collector foil 31 and positive electrode active material layers 32, 33 provided on both surfaces of the positive current collector foil 31. Each of the positive electrode foils 11a, 11b therefore includes the positive current collector foil 31 and the positive electrode active material layers 32, 33 provided on both surfaces thereof. The positive current collector foil 31 is made of aluminum, an aluminum alloy, etc. The positive electrode active material layers 32, 33 are made of a carbon material capable of reversibly supporting anions and cations, a binder, a conducting agent, etc. Carbon black such as acetylene black or Ketjen black, natural graphite, thermal expansion graphite, carbon fibers, etc. is used as the conducting agent. A fluorine-containing resin such as polytetrafluoroethylene or polyvinylidene fluoride, a rubber binder such as styrene-butadiene rubber, a thermoplastic resin such as polypropylene or polyethylene, etc. is used as the binder.

As shown in FIGS. 1 and 2, adjoining two of the negative electrode foils 12a, 12b and their corresponding negative external terminals 15a, 15b are formed by an integral negative electrode material foil 40. That is, a single negative electrode material foil 40 is folded in the middle to be divided into a surface having the first negative electrode foil 12a and the first negative external terminal 15a and a surface having the second negative electrode foil 12b and the second negative external terminal 15b. That is, the length of the single negative electrode material foil 40 is equal to the sum of the lengths of the two negative electrode foils 12a.

The negative electrode material foil 40 includes a negative current collector foil 31 and negative electrode active material layers 42, 43 provided on both surfaces of the negative current collector foil 41. Each of the negative electrode foils 12a, 12b therefore includes the negative current collector foil 41 and the negative electrode active material layers 42, 43 provided on both surfaces thereof. The negative current collector foil 41 is made of copper, a copper alloy, nickel, stainless steel, etc. The negative electrode active material layers 42, 43 are made of a carbon material such as graphite or amorphous carbon, a binder, a conducting agent, etc. The conducting agent and the binder are similar to those of the positive electrode active material layers 32, 33.

As shown in FIG. 2, the second surface (11b, 14b) of the folded positive electrode material foil 30 is placed inside the folded negative electrode material foil 40. That is, the second surface (11b, 14b) of the positive electrode material foil 30 faces the first surface (12a, 15a) and the second surface (12b, 15b) of the negative electrode material foil 40. The first surface (12a, 15a) of the folded negative electrode material foil 40 is placed inside the folded positive electrode material foil 30. That is, the first surface (12a, 15a) of the negative electrode material foil 40 faces the first surface (11a, 14a) and the second surface (11b, 14b) of the positive electrode material foil 30.

A single continuous strip-shaped separator foil 13 is interposed between the positive electrode material foil 30 and the negative electrode material foil 40. Paper made of viscose rayon or native cellulose, nonwoven fabric made of polyethylene or polypropylene, etc. is used as the separator foil 13. The separator foil 13 need be made of an insulating material the electrolyte solution 22 easily penetrates.

As shown in FIG. 2, the single positive electrode material foil 30, the single negative electrode material foil 40, and the separator foil 13 interposed therebetween form a single unit 50. The electricity storage member 10 is formed by stacking a plurality of units 50. In this case, the separator foil 13 extends continuously in the plurality of units 50.

In the lithium ion capacitor 1 configured as described above, the plurality of positive electrode foils 11a, 11b and the plurality of negative electrode foils 12a, 12b are stacked with the separator foils 13 interposed therebetween. The larger the area where the active material layers 32, 33, 42, 43 of each electrode foil 11a, 11b, 12a, 12b face each other in the lithium ion capacitor 1 is, the higher the performance of the lithium ion capacitor 1 is. The size of the outer shape of the lithium ion capacitor 1 depends on the size of each electrode foil 11a, 11 b, 12a, 12b and the magnitude of a positional offset of each electrode foil 11a, 11 b, 12a, 12b. That is, the larger the positional offset of each electrode foil 11a, 11b, 12a, 12b is, the larger the size of the lithium ion capacitor 1 becomes. Lithium ion capacitors are desired to have both improved performance and a reduced size. The lithium ion capacitor 1 of the present embodiment achieves both improved performance and a reduced size by using the above configuration and a method for manufacturing the electricity storage member 10 described below.

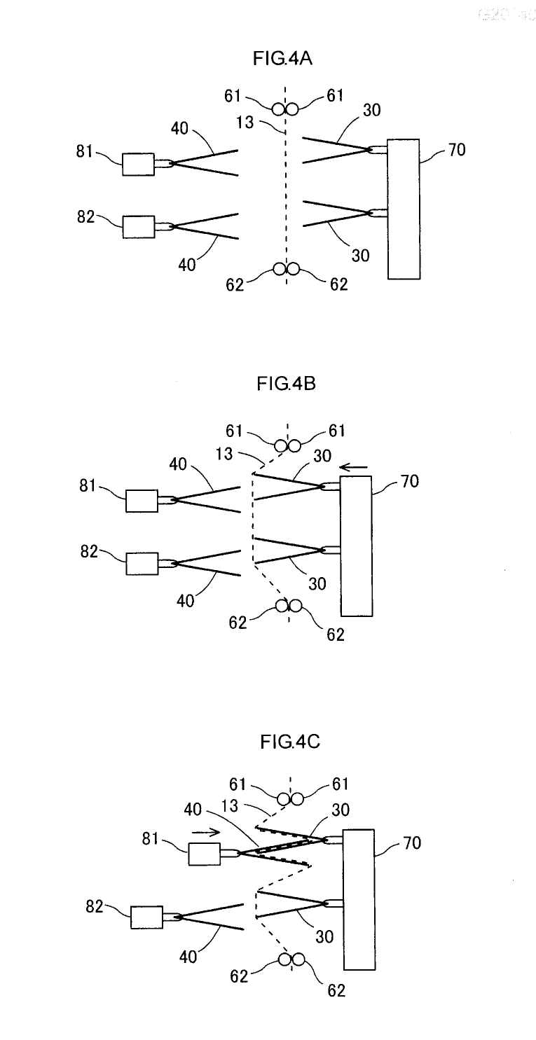

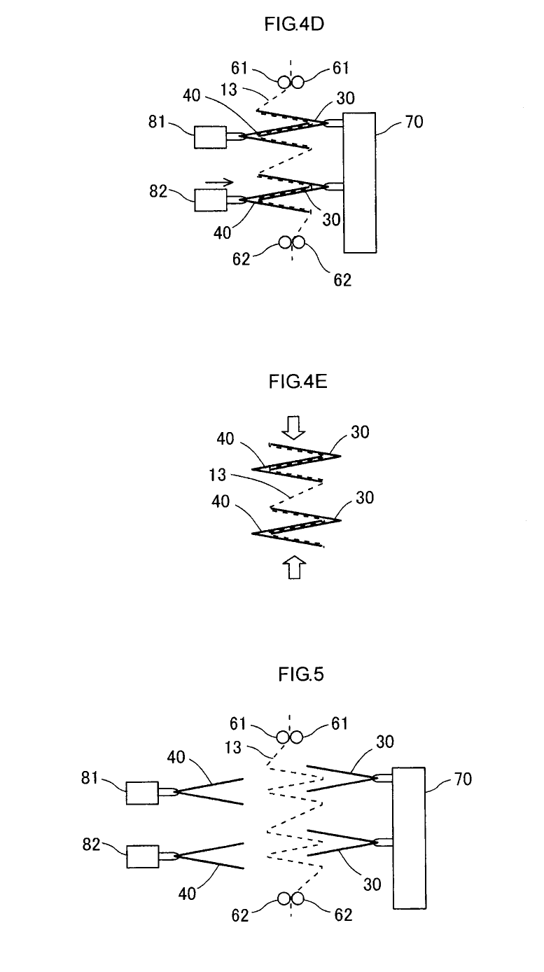

A method for manufacturing the electricity storage member 10 will be described with reference to FIGS. 3 and 4A to 4E. In FIGS. 4A to 4E, the separator foil 13 is shown by dashed lines for convenience. The positive electrode material foil 30 having a length equal to the sum of the lengths of the two positive electrode foils 11a is prepared as shown in FIG. 3. This positive electrode material foil 30 is folded in the middle to form the folded positive electrode material foil 30 (positive electrode folding step). The positive electrode material foil 30 in this state is formed so that the distance between the two sides of the folded positive electrode material foil 30 increases toward the opening. A plurality of such folded positive electrode material foils 30 are prepared.

The negative electrode material foil 40 having a length equal to the sum of the lengths of the two negative electrode foils 12a is prepared. This negative electrode material foil 40 is folded in the middle to form the folded negative electrode material foil 40 (negative electrode folding step). The negative electrode material foil 40 in this state is formed so that the distance between the two sides of the folded negative electrode material foil 40 increases toward the opening. A plurality of such folded negative electrode material foils 40 are prepared.

Then, the separator foil 13 is held by upper rollers 61, 61 and lower rollers 62, 62 and adjusted so as to be subjected to predetermined tension (separator foil placing step). In the present embodiment, the separator foil 13 is formed in a strip shape with no fold line.

As shown in FIGS. 3 and 4A, the folded parts of the plurality of positive electrode material foils 30 are then held by a holding device 70, and are arranged on the first surface side of the separator foil 13 such that the openings of the plurality of positive electrode material foils 30 face the separator foil 13. The folded parts of the plurality of negative electrode material foils 40 are held by holding devices 81, 82, respectively, each capable of moving independently, and are arranged on the second surface side of the separator foil 13 such that the openings of the plurality of negative electrode material foils 40 face the separator foil 13. That is, the plurality of positive electrode material foils 30 and the plurality of negative electrode material foils 40 are arranged with the separator foil 13 interposed therebetween such that the openings of the folded positive electrode material foils 30 face the openings of the folded negative electrode material foils 40 (initial arranging step).

More specifically, as shown in FIG. 4A, the vertical positions of the positive electrode material foil 30 and the negative electrode material foil 40 which form each unit 50 in FIG. 4A are adjusted so that one end of the negative electrode material foil 40 faces the bottom of the valley of the positive electrode material foil 30 and that the bottom of the valley of the negative electrode material foil 40 faces one end of the positive electrode material foil 30.

Then, as the holding device 70 is moved, the plurality of positive electrode material foils 30 are simultaneously brought into contact with the separator foil 13 and moved to a predetermined position shown in FIG. 4B. At this time, the upper rollers 61, 61 and the lower rollers 62, 62 are operated to adjust the tension on the separator foil 13. The holding device 70 integrally holds the plurality of positive electrode material foils 30, and restricts relative movement of the plurality of positive electrode material foils 30. The relative positions of the plurality of positive electrode material foils 30 held by the holding device 70 are therefore always constant.

Thereafter, as shown in FIG. 4C, the holding device 81 holding one negative electrode material foil 40 is moved toward the separator foil 13, i.e., toward the positive electrode material foil 30. First, the opening end of this negative electrode material foil 40 is brought into contact with the separator foil 13. As the negative electrode material foil 40 is further moved, the one end of the negative electrode material foil 40 is inserted from the opening of the single positive electrode material foil 30 toward the bottom of the valley thereof while pressing the separator foil 13. The negative electrode material foil 40 is restrained by the bottom of the valley of the positive electrode material foil 30, and the negative electrode material foil 40 and the positive electrode material foil 30 are thus positioned (positioning step). The one end of the negative electrode material foil 40 is restrained by the bottom of the valley of the positive electrode material foil 30, and at the same time the one end of the positive electrode material foil 30 is restrained by the bottom of the valley of the negative electrode material foil 40. The bottom of the valley of each material foil and one end of its corresponding material foil thus restrain each other, whereby the positive and negative electrode material foils 30, 40 are positioned. Namely, a single unit 50 is formed.

As shown in FIG. 4D, the holding device 82 holding another negative electrode material foil 40 is then moved toward the separator foil 13, i.e., toward the positive electrode material foil 30. The operation in this case is similar to that in the case where the holding device 81 is operated. Another unit 50 is thus formed.

Subsequently, as shown in FIG. 4E, the separator foil 13 is separated from the upper rollers 61, 61 and the lower rollers 62, 62. The plurality of positive electrode material foils 30, the plurality of negative electrode material foils 40, and the separator foil 13, which have been positioned, are then compressed by a force applied in the vertical direction in FIG. 4E, whereby the electricity storage member 10 is manufactured. In this case, relative movement of the members 30, 40, 13 of the electricity storage member 10 in the vertical direction is permitted, but relative movement of the members 30, 40, 13 of the electricity storage member 10 in the lateral direction is restricted. In the above manufacturing method, the holding device 70 may integrally hold the plurality of negative electrode material foils 40, and the holding devices 81, 82 may hold the positive electrode material foils 30, respectively.

Advantageous effects of the present embodiment will be described below. As described above, the electricity storage member 10 uses the positive electrode material foils 30 each having a length equal to the sum of the lengths of two positive electrode foils 11a, and the negative electrode material foils 40 each having a length equal to the sum of the lengths of two negative electrode foils 12a. One end of the folded negative electrode material foil 40 is restrained by the bottom of the valley of the folded positive electrode material foil 30, whereby the positive electrode material foil 30 and the negative electrode material foil 40 are positioned. Because the positive electrode material foil 30 and the negative electrode material foil 40 are more rigid than the separator foil 13, rigidity at the bottoms of the folds of the positive electrode material foil 30 and the negative electrode material foil 40 is higher than that at the fold line of the separator foil 13. The positive electrode material foil 30 and the negative electrode material foil 40 are thus accurately positioned in a manner described above. The manufactured lithium ion capacitor 1 can thus achieve both improved performance and a reduced size.

Moreover, the positive electrode material foil 30 and the negative electrode material foil 40 are accurately positioned in each unit 50. The multi-layer electricity storage member 10 is formed by positioning and stacking the plurality of units 50. The lithium ion capacitor 1 capable of achieving both improved performance and a reduced size is manufactured. Moreover, the positive electrode material foil 30 includes the active material layers 32, 33 on both surfaces of the positive current collector foil 31, and the negative electrode material foil 40 includes the active material layers 42, 43 on both surfaces of the negative current collector foil 41. The electricity storage member 10 is manufactured by stacking the plurality of units 50 as follows. As shown in FIG. 2, in the case where the positive electrode material foil 30 is exposed at a first end face of one unit 50, the negative electrode material foil 40 is exposed at a first end face of another unit 50 to be stacked on this unit 50, namely the unit 50 adjoining this unit 50. This stacking method allows a portion where the positive electrode material foil 30 of one unit 50 faces the negative electrode material foil 40 of the unit 50 adjoining this unit 50 to have a function to store electricity. Accordingly, the lithium ion capacitor 1 having the above configuration can improve electricity storage performance while reducing the number of positive electrode material foils 30 and negative electrode material foils 40.

In particular, the holding device 70 restricts relative movement of the plurality of positive electrode material foils 30. The plurality of positive electrode material foils 30 can therefore be accurately positioned with respect to each other. In this state, the positive and negative electrode material foils 30, 40 are moved toward each other, whereby the positive and negative electrode material foils 30, 40 are positioned so that each positive electrode material foil 30 overlaps a corresponding one of the negative electrode material foils 40. In each unit 50, the positive and negative electrode material foils 30, 40 are accurately positioned as one end of the negative electrode material foil 40 is restrained by the bottom of the valley of the positive electrode material foil 30 as described above. Moreover, because relative movement of the plurality of positive electrode material foils 30 is restricted, positioning accuracy of the plurality of units 50 depends on the initial positions of the plurality of positive electrode material foils 30 held by the holding device 70. That is, the plurality of units 50 can be accurately positioned. The electricity storage member 10 can therefore achieve both improved performance and a reduced size.

The separator foil 13 is formed in the shape of a single strip. In the initial arranging step, the separator foil 13 is interposed between the plurality of positive electrode material foils 30 and the plurality of negative electrode material foils 40. Because the separator foil 13 need not be cut into pieces, manufacturing can be facilitated.

In particular, in the present embodiment, the separator foil 13 is formed in a strip shape with no fold line, and the separator foil 13 is folded as the folded positive electrode material foil 30 and the folded negative electrode material foil 40 are relatively moved toward each other in the positioning step. Because no fold line need be formed in advance in the separator foil 14, manufacturing cost can be reduced. In this case, the separator foil 13 is folded by the positive electrode material foil 30 and the negative electrode material foil 40.

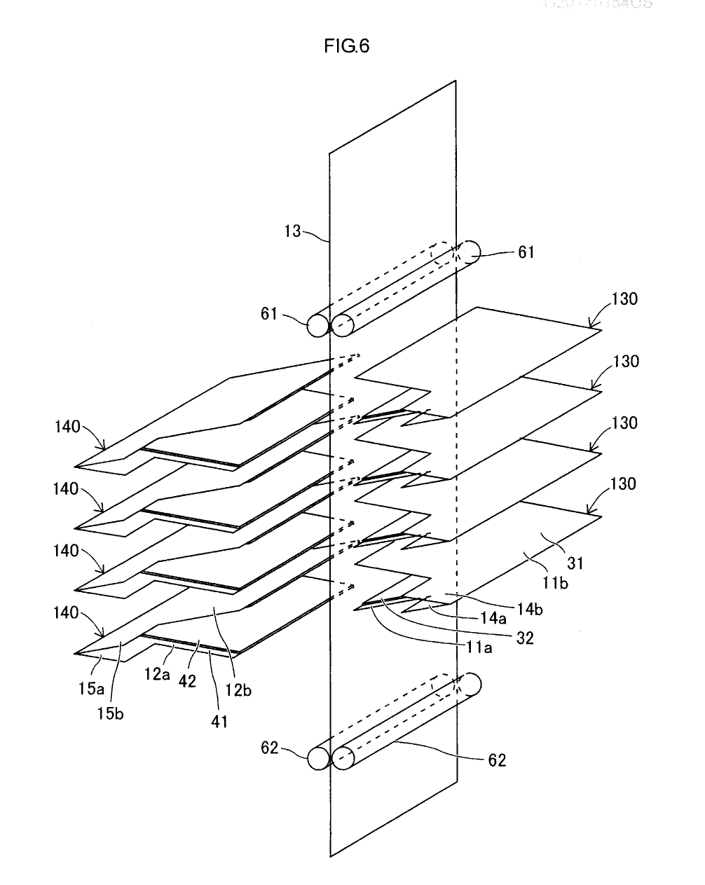

A second embodiment of the invention will be described below. As shown in FIGS. 3 and 4A, the separator foil 13 having a strip shape with no fold line is used in the first embodiment. In the second embodiment, as shown in FIG. 5, the separator foil 13 is formed in a strip shape with fold lines. These fold lines are formed so as to correspond to the positions where the ends and the bottoms of the folds of the folded positive and negative electrode material foils 30, 40 are to be located as a result of positioning the folded positive and negative electrode material foils 30, 40 in the positioning step. In this case, the separator foil 13 is interposed between the positive electrode material foil 30 and the negative electrode material foil 40 as the folded positive electrode material foil 30 and the folded negative electrode material foil 40 are relatively moved toward each other in the positioning step. This reduces a tensile force that is applied to the separator foil 13 when the separator foil 13 is pressed by the positive electrode material foil 30 and the negative electrode material foil 40. The separator foil 13 can therefore be reliably prevented from tearing.

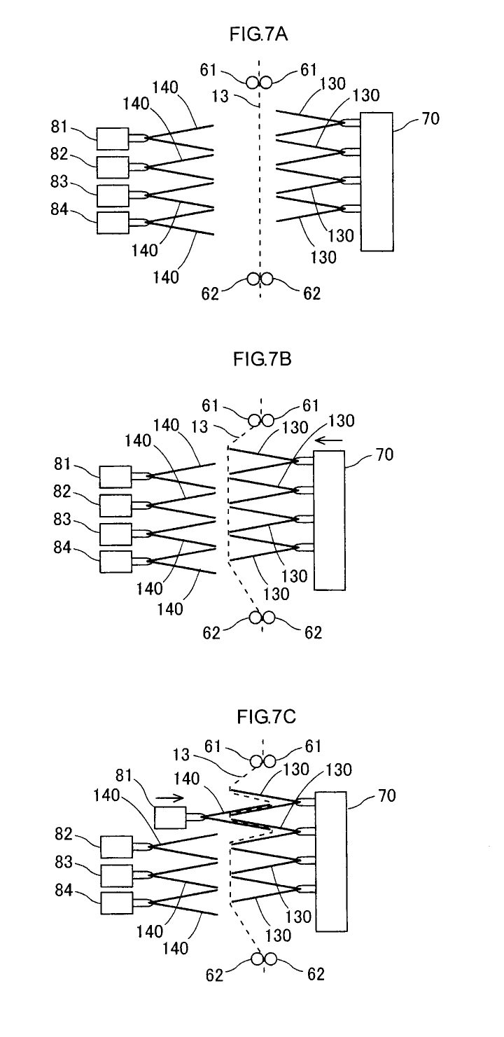

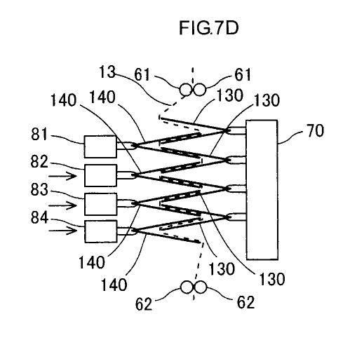

A third embodiment of the invention will be described below. In the first embodiment, the positive electrode material foil 30 has the active material layers 32, 33 on both surfaces of the current collector foil 31, and the negative electrode material foil 40 has the active material layers 42, 43 on both surfaces of the current collector foil 41. Alternatively, positive and negative electrode material foils 130, 140 having an active material layer 32, 42 only on one surface of the current collector foil 31, 41 can be used, respectively. A method for manufacturing the electricity storage member 10 in this case will be described with reference to FIGS. 6 and 7A to 7D.

In the initial arranging step, as shown in FIGS. 6 and 7A, the positive and negative electrode material foils 130, 140 are positioned such that the bottom of the valley of one positive electrode material foil 130 faces one ends of two negative electrode material foils 140 and that the bottom of the valley of one negative electrode material foil 140 faces one ends of two positive electrode material foils 130. The holding device 70 holds the plurality of positive electrode material foils 130. Holding devices 81 to 84 capable of operating independently hold the negative electrode material foils 140, respectively.

Then, as shown in FIG. 7B, the holding device 70 is moved to bring the plurality of positive electrode material foils 130 into contact with the separator foil 13. Thereafter, as shown in FIG. 7C, the holding device 81 is moved to move one negative electrode material foil 140 toward one positive electrode material foil 130. One end of this negative electrode material foil 140 is restrained by the bottom of the valley of the positive electrode material foil 130, whereby these positive and negative material foils 130, 140 are positioned. The other negative electrode material foils 140 are similarly positioned as shown in FIG. 7D. The positive and negative electrode material foils and the separator foil that have been positioned are compressed in the vertical direction in FIG. 7D. The electricity storage member 10 is thus manufactured.

What is claimed is:

1. A method for manufacturing an electricity storage device including an electricity storage member in which positive electrode foils and negative electrode foils are alternately stacked with separator foils interposed therebetween, comprising:
a positive electrode folding in which a positive electrode material foil having a length equal to a sum of lengths of two of the positive electrode foils is folded in a middle;
a negative electrode folding in which a negative electrode material foil having a length equal to a sum of lengths of two of the negative electrode foils is folded in a middle;
an initial arranging in which the positive electrode material foil and the negative electrode material foil are arranged with the separator foils interposed therebetween such that an opening of the folded positive electrode material foil faces an opening of the folded negative electrode material foil; and
a positioning in which the positive electrode material foil and the negative electrode material foil are positioned by relatively moving the folded positive electrode material foil and the folded negative electrode material foil closer to each other so as to insert one end of a second material foil among the positive and negative electrode material foils from the opening of a first material foil among the positive and negative electrode material foils toward a bottom of a valley of the first material foil, and in which the one end of the second material foil is restrained with the bottom of the valley of the first material foil.

2. The method for manufacturing an electricity storage device according to claim 1, wherein
the positive electrode material foil includes a positive current collector foil and positive electrode active material layers placed on both surfaces of the positive current collector foil, and
the negative electrode material foil includes a negative current collector foil and negative electrode active material layers placed on both surfaces of the negative current collector foil, wherein
a single unit includes one positive electrode material foil, one negative electrode material foil, and one separator foil that is interposed between the one positive electrode material foil and the one negative electrode material foil, and the single unit is formed by the positive electrode folding, the negative electrode folding, the initial arranging, and the positioning, wherein
the electricity storage member is manufactured by stacking a plurality of the units.

3. The method for manufacturing an electricity storage device according to claim 2, wherein
in the positive electrode folding, each of a plurality of the positive electrode material foils is folded in the middle,
in the negative electrode folding, each of a plurality of the negative electrode material foils is folded in the middle,
in the initial arranging, relative movement of the plurality of positive electrode material foils is restricted to each other, or relative movement of the plurality of negative electrode material foils is restricted to each other, and
in the positioning, the plurality of positive electrode material foils and the plurality of negative electrode material foils are positioned by relatively moving the plurality of folded positive electrode material foils and the plurality of folded negative electrode material foils closer to each other so as to insert one ends of second material foils among the positive and negative electrode material foils, which face bottoms of valleys of first material foils among the positive and negative electrode material foils, from openings of the first material foils toward the bottoms of the valleys of the first material foils, and the one ends of the second material foils is restrained with the bottoms of the valleys of the first material foils.

4. The method for manufacturing an electricity storage device according to claim 1, wherein
the separator foil is formed in a shape of a single strip, and
in the initial arranging, the separator foil is interposed between the plurality of positive electrode material foils and the plurality of negative electrode material foils.

5. The method for manufacturing an electricity storage device according to claim 4, wherein
the separator foil is formed in a strip shape with no fold line, and
the separator foil is folded when the folded positive electrode material foils and the folded negative electrode material foils are relatively moved closer to each other in the positioning.

6. The method for manufacturing an electricity storage device according to claim 4, wherein
the separator foil is formed in a strip shape with fold lines, and the fold lines are formed so as to correspond to positions where the ends and the bottoms of the valleys are to be located as a result of positioning the folded positive electrode material foils and the folded negative electrode material foils in the positioning, and
the separator foil is interposed between the positive electrode material foils and the negative electrode material foils by moving the folded positive electrode material foils and the folded negative electrode material foils relatively closer to each other in the positioning.

7. The method for manufacturing an electricity storage device according to claim 1, wherein
the positive electrode material foil includes a positive current collector foil and a positive electrode active material layer placed on one surface of the positive current collector foil, and
the negative electrode material foil includes a negative current collector foil and a negative electrode active material layer placed on one surface of the negative current collector foil, wherein
the electricity storage member includes a plurality of the positive electrode material foils, a plurality of the negative electrode material foils, and one separator foils interposed between the positive electrode material foils and the negative electrode material foils, and the electricity storage member is formed by the positive electrode folding, the negative electrode folding, the initial arranging, the positioning, and a stacking the positive electrode material foils, the negative electrode material foils, and the separator foil, wherein
in the positioning, one ends of adjoining two of second material foils among the folded positive and negative electrode material foils are inserted from an opening of one of first material foils among the folded positive and negative electrode material foils toward a bottom of a valley of the one first material foil.

8. The method for manufacturing an electricity storage device according to claim 7, wherein
in the positive electrode folding, each of the plurality of positive electrode material foils is folded in the middle,
in the negative electrode folding, each of the plurality of negative electrode material foils is folded in the middle,
in the initial arranging, relative movement of the plurality of positive electrode material foils is restricted to each other, or the plurality of negative electrode material foils is restricted to each other, and
in the positioning, the plurality of positive electrode material foils and the plurality of negative electrode material foils are positioned by relatively moving the plurality of folded positive electrode material foils and the plurality of folded negative electrode material foils closer to each other, and the one ends of the second material foils is restrained with the bottoms of the valleys of the first material foils.

9. The method for manufacturing an electricity storage device according to claim 7, wherein
the separator is formed in a shape of a single strip, and
in the initial arranging, the separator foil is interposed between the plurality of positive electrode material foils and the plurality of negative electrode material foils.

10. The method for manufacturing an electricity storage device according to claim 9, wherein
the separator foil is formed in a strip shape with no fold line, and
the separator foil is folded when the folded positive electrode material foils and the folded negative electrode material foils are relatively moved closer to each other in the positioning.

11. The method for manufacturing an electricity storage device according to claim 9, wherein
the separator foil is formed in a strip shape with fold lines, and the fold lines are formed so as to correspond to positions where the ends and the bottoms of the valleys are to be located as a result of positioning the folded positive electrode material foils and the folded negative electrode material foils in the positioning, and
the separator foil is interposed between the positive electrode material foils and the negative electrode material foils by moving the folded positive electrode material foils and the folded negative electrode material foils relatively moved t closer to each other in the positioning.
